(19) United States
(12) Patent Application Publication
(10) Pub. No.: US 2008/0102331 A1
(43) Pub. Date: May 1, 2008

(54) FUEL CELL SYSTEM

(75) Inventor: Kazumasa TAKADA, Nishikamo-gun (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/869,209

(22) Filed: Oct. 9, 2007

(30) Foreign Application Priority Data
Oct. 25, 2006 (JP) 2006-289800

(51) Int. Cl. H01M 8/06

(52) U.S. Cl. 429/20

(57) ABSTRACT

A fuel cell system is provided with a fuel cell, a reforming section, a burner section and a system controller, wherein in supplying offgas from a fuel pole of the fuel cell to the burner section, the system controller regulates the combustion at the burner section in consideration of the fact that the burner section is supplied with at least one of reforming fuel and combustion fuel which exists in the fuel pole of the fuel cell. Thus, even where the burner section is supplied with combustible fuel which differs from the combustible fuel existing in the fuel pole of the fuel cell, the air-fuel ratio can be maintained adequately, so that the emission of the exhaust gas from the burner section 25 can be prevented from becoming worse.

### INCORPORATION BY REFERENCE

This application is based on and claims priority under 35 U.S.C. 119 with respect to Japanese Application No. 2006-289800 filed on Oct. 25, 2006, the entire content of which is incorporated herein by reference.

### BACKGROUND OF THE INVENTION

1. Field of the Invention

The present invention relates to a fuel cell system for generating electric power.

2. Discussion of the Related Art

As one form of fuel cell systems, there has been known a fuel cell system which is described in Japanese unexamined patent application No. 2003-229156. As shown in FIG. 1 of the Japanese application, in the fuel cell system, when a reformer 30 and a fuel cell 40 are to be purged prior to an operation stop of the system, a regulator valve 38 is closed to discontinue the supply of steam to city gas as reforming material supplied to the reformer 30, and a regulator valve 47 and a regulator valve 48 are respectively closed and opened, whereby gas which is pressured by the city gas to be discharged from the fuel cell 40 is led to a burner 49 to be burned and exhausted. Then, upon completion of purging all of the reformer 30, a CO selective oxidizing section 34 and the fuel cell 40, a regulator valve 28 and the regulator valve 48 are closed to complete a purge processing. In this way, the reformer 30 and the fuel cell 40 can be purged by using as purge gas the city gas used as reforming material.

In the fuel system, where the warm-up of the reformer 30 has not been completed at the time of an operation start, carbon monoxide in the reforming gas is high in density and would damage catalyzer in the fuel cell 40. To prevent this, it has been conventional that the reforming gas from the reformer 30 is caused to bypass the fuel cell 40 and is led to the burner 49 to burn. Then, when the warm-up of the reformer 30 is completed, the density of carbon monoxide in the reforming gas becomes low, and switching is made to supply the reforming gas from the reformer 30 to the fuel cell 40 and to lead offgas from a fuel pole of the fuel cell 40 to the burner 49 for combustion.

In the fuel cell system described in the aforementioned Japanese application, the aforementioned switching of combustible fuel to the burner 49 is carried out with city gas remaining in the fuel pole of the fuel cell 40. As a result, offgas differing from the reforming gas which has been supplied to the burner 49 until then is suddenly supplied the burner 49. This gives rise to problems that it becomes difficult to maintain an adequate air-fuel ratio depending on the supply quantity of the combustible fuel and hence, that the emission of the exhaust gas from the burner 48 is deteriorated.

### SUMMARY OF THE INVENTION

Accordingly, it is a primary object of the present invention to provide a fuel cell system capable of preventing the emission of exhaust gas from a burner section from being deteriorated even where the burner section is supplied with combustible fuel from a fuel pole of a fuel cell in which the combustible fuel differing from reforming gas is remaining.

Briefly, according to the present invention, there is provided a fuel cell system, which comprises a fuel cell for generating electric power through the reaction of fuel gas with oxidizer gas which are supplied respectively to a fuel pole and an oxidizer pole thereof; a reforming section for generating the fuel gas from reforming fuel supplied from reforming fuel supply means; and a burner section for burning either combustible fuel of combustion fuel supplied from combustion fuel supply means, the fuel gas supplied from the reforming section and offgas supplied from the fuel pole, with combustion oxidizer gas supplied from combustion oxidizer gas supply means and for heating the reforming section with combustion gas. The system further comprises supply means for supplying either one of the reforming fuel and the combustion fuel to the fuel pole of the fuel cell; and a system controller including combustion regulation means for regulating combustion at the burner section, wherein in supplying the offgas from the fuel pole to the burner section, the system controller regulates, through the combustion regulation means, the combustion at the burner section in consideration of the fact that the burner section is supplied with at least one of reforming fuel and combustion fuel which exists in the fuel pole of the fuel cell.

With this construction, in supplying the offgas from the fuel pole to the burner section, the system controller takes into consideration the fact that the burner section is supplied with either one of the existing reforming fuel and the combustion fuel, and regulates the combustion at the burner section (combustion regulation means). Therefore, even if the burner section is suddenly supplied with combustible fuel which exists in the fuel pole of the fuel cell and which differs from the combustible fuel having been supplied to the burner section until then, the combustion at the burner section is regulated taking into consideration the fact that the burner section is supplied with the combustible fuel which exists in the fuel pole of the fuel cell. Therefore, an adequate air-fuel ratio depending on the supply quantity of the combustible fuel is maintained, so that the emission of exhaust gas from the burner section can be prevented from being deteriorated or from becoming worse.

### BRIEF DESCRIPTION OF THE ACCOMPANYING DRAWINGS

The foregoing and other objects and many of the attendant advantages of the present invention may readily be appreciated as the same becomes better understood by reference to the preferred embodiment of the present invention when considered in connection with the accompanying drawings, wherein like reference numerals designate the same or corresponding parts throughout several views, and in which:

FIG. 1 is a schematic view showing the outline of a fuel cell system in one embodiment according to the present invention;

FIG. 2 is a block diagram showing a system control configuration of the fuel cell system shown in FIG. 1;

FIG. 3 is a flow chart showing a control program executed by a system controller shown in FIG. 2;

FIG. 4 is a flow chart showing a warm-up operation routine executed by the system controller;

FIG. 5 is a flow chart showing a stopping operation routine executed by the system controller;

FIG. 6 is a time chart showing the transitions of a reformer warm-up mode, an FC connection control mode and an ordinary power generation mode in the operation of the fuel cell system executed in accordance with the flow chart shown in FIG. 3; and

FIG. 7 is a time chart showing post-processing after a power generation stop in the operation of the fuel cell system executed in accordance with the flow chart shown in FIG. 3.

### DETAILED DESCRIPTION OF THE PREFERRED EMBODIMENT

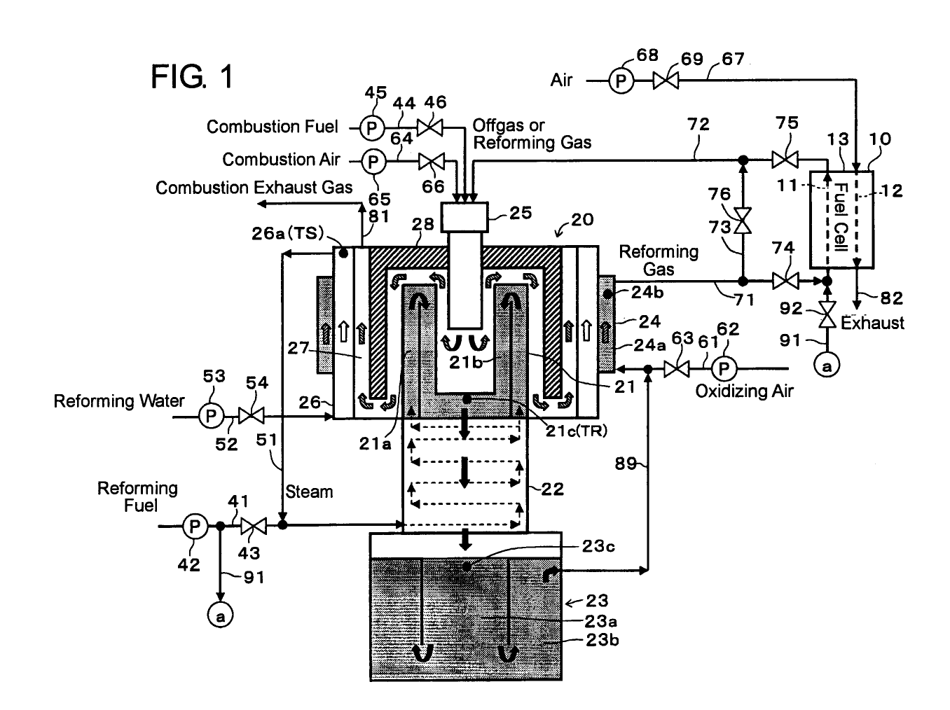

Hereafter, a fuel cell system in one embodiment according to the present invention will be described with reference to the drawings. FIG. 1 is a schematic view showing the outline of the fuel cell system. The fuel cell system is provided with a fuel cell 10 and a reformer 20 for generating reforming gas (fuel gas) containing hydrogen gas needed for the fuel cell 10.

The fuel cell 10 is provided with a fuel pole 11, an air pole 12 as an oxidizing agent or oxidizer pole, and an electrolyte 13 which comprises an ion exchange membrane interposed between both of the poles 11 and 12. The fuel cell 10 is operable to generate electric power by using reforming gas supplied to the fuel pole 11 and air (cathode gas) as oxidizer gas supplied to the air pole 12. Instead of air, there may be supplied gas which is air enriched with oxygen.

The reformer 20 steaming-reforms reforming fuel and supplies the fuel cell 10 with hydrogen-rich reforming gas. The reformer 20 is composed of a reforming section 21, a cooler section 22, a carbon monoxide shift reaction section (hereafter referred to as “CO shift section”) 23 and a carbon monoxide selective oxidation reaction section (hereafter referred to as “CO selective oxidation section”) 24, a combustion or burner section 25 and an evaporator section 26. As the reforming fuel, there may be employed reforming gaseous fuel such as natural gas, LPG or the like, or reforming liquid fuel such as kerosene, gasoline, methanol or the like. The present embodiment will hereafter be described in a form using natural gas as the reforming fuel.

The reforming section 21 generates and derives reforming gas from a mixture gas as reforming material in which steam is mixed with the reforming fuel. The reforming section 21 takes a bottomed cylindrical form and is provided in an annular cylinder with an annular turnover flow passage 21a extending along the axis of the annular cylinder. The reforming section 21 is made of stainless steel.

The turnover flow passage 21a of the reforming section 21 is filled with catalyzer 21b (e.g., ruthenium (Ru) or nickel (Ni) base catalyzer), and mixture gas which is the mixture of the reforming fuel introduced from the cooler section 22 with steam introduced from a steam supply pipe 51 reacts through the catalyzer 21b to generate hydrogen gas and carbon monoxide gas (a so-called steam reforming reaction). At the same time, a so-called carbon monoxide shift reaction takes place, in which the carbon monoxide which is generated through the steam reforming reaction reacts with steam to be regenerated into hydrogen gas and carbon dioxide. These regenerated gases (so-called “reforming gas” collectively) are led to the cooler section (heat exchange section) 22. The steam reforming reaction is an endothermic reaction, whereas the carbon monoxide shift reaction is an exothermic reaction.

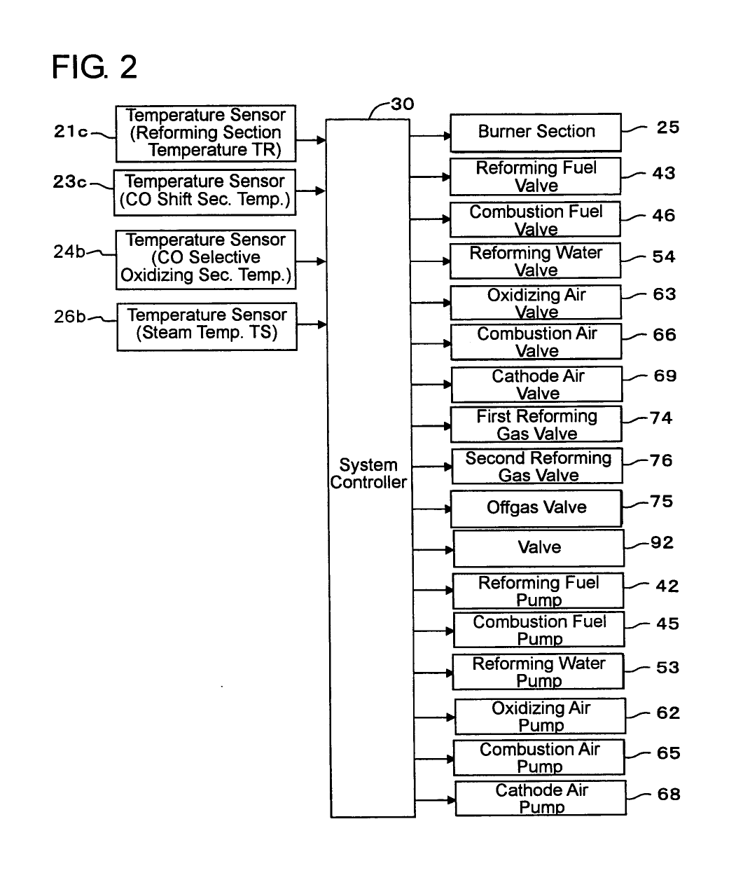

Further, the reforming section 21 is provided therein with a temperature sensor 21c for measuring the temperature in the reforming section 21 such as, e.g., the temperature (TR) in the neighborhood of a wall which is adjacent to the burner section 25. The detection result is transmitted to a system controller 30, referred to later with reference to FIG. 2.

The cooler section 22 is constituted by a heat exchanger (heat exchange section) for performing heat exchange between the reforming gas led from the reforming section 21 and the mixture of reforming fuel and reforming water (steam). The cooler section 22 lowers the temperature of the high-temperature reforming gas with the low-temperature mixture gas to lead the reforming gas to the CO shift section 23 while raising the temperature of the mixture gas with the reforming gas to lead the mixture gas to the reforming section 21.

Specifically, the cooler section 22 has connected thereto a fuel supply pipe 41 which is connected to a fuel supply source (not shown) such as, e.g., a city gas pipe. The fuel supply pipe 41 is provided thereon with a reforming fuel pump 42 and a reforming fuel valve 43 in order from the upstream side. The reforming fuel valve 43 operates to open or close the fuel supply pipe 41. The reforming fuel pump 42 serves as reforming fuel supply means for supplying reforming fuel and for regulating the supply quantity. Further, a steam supply pipe 51 connected to the evaporator section 26 is connected to the fuel supply pipe 41 between the reforming fuel valve 43 and the cooler section 22. The steam supplied from the evaporator section 26 is mixed with reforming fuel, and the resultant mixture gas is supplied to the reforming section 21 by way of the cooler section 22.

The CO shift section 23 is a carbon monoxide reduction section for reducing the carbon monoxide in the reforming gas supplied from the reforming section 21 by way of the cooler section 22. The CO shift section 23 is provided therein with a turnover flow passage 23a extending in a vertical direction. The turnover flow passage 23a is filled with catalyzer 23b (e.g., copper (Cu)-zinc (Zn) base catalyzer). In the CO shift section 23, a so-called carbon monoxide shift reaction takes place, in which the carbon monoxide and the steam contained in the reforming gas led from the cooler section 22 react through the catalyzer 23b to be regenerated into hydrogen gas and carbon dioxide gas. This carbon monoxide shift reaction is an exothermic reaction.

Further, the CO shift section 23 is provided therein with a temperature sensor 23c for measuring the temperature in the CO shift section 23. The detection result of the temperature sensor 23c is transmitted to the system controller 30.

The CO selective oxidation section 24 is also another carbon monoxide reduction section for further reducing the carbon monoxide in the reforming gas supplied from the CO shift section 23 to supply the reforming gas to the fuel cell 10. The CO selective oxidation section 24 takes an annular cylindrical form and is provided in contact with the outer circumferential wall of the evaporator section 26 to cover the outer circumferential wall. The CO selective oxidation section 24 is filled with catalyzer 24a (e.g., ruthenium (Ru) or platinum (Pt) base catalyzer).

Further, the CO selective oxidation section 24 is provided therein with a temperature sensor 24b for measuring the temperature in the CO selective oxidation section 24. The detection result of the temperature sensor 24b is transmitted to the system controller 30.

The CO selective oxidation section 24 is connected at lower and upper portions of its lateral wall surface respectively to a connection pipe 89 connected to the CO shift section 23 and a reforming gas supply pipe 71 connected to the fuel pole 11 of the fuel cell 10. The connection pipe 89 has an oxidizing air supply pipe 61 connected thereto. Thus, the CO selective oxidation section 24 can be supplied with the reforming gas from the CO shift section 23 and oxidizing air from the atmosphere. The oxidizing air supply pipe 61 is provided thereon with an oxidizing air pump 62 and an oxidizing air valve 63 in order from the upstream side. The oxidizing air pump 62 is for supplying oxidizing air and for regulating the supply quantity. The oxidizing air valve 63 operates to open or close the oxidizing air supply pipe 61.

Accordingly, the carbon monoxide in the reforming gas led to the CO selective oxidation section 24 reacts to (is oxidized with) oxygen in the oxidizing air to become carbon dioxide. This reaction is an exothermic reaction and is expedited by the catalyzer 24a. Thus, the reforming gas is further reduced (less than 10 ppm) in the density of carbon monoxide through oxidation reaction and is supplied to the fuel pole 11 of the fuel cell 10.

The burner section 25 burns at least either combustible fuel of the combustion fuel supplied by a combustion fuel pump 45, the reforming gas supplied from the reforming section 21 and the offgas supplied from the fuel pole 11 of the fuel cell 10, with the combustion air supplied from a combustion air pump 65 and heats the reforming section 21 with combustion gas. The burner section 25 generates combustion gas to heat the reforming section 21 and to supply the same with heat necessary for the steam reforming reaction. The burner section 25 is arranged inside the reforming section 21, with its lower end portion being inserted into a cylindrical space in an inner circumferential wall of the reforming section 21 and being spaced from the inner circumferential wall. The combustion fuel is a combustible fuel of the same kind as the reforming fuel.

The burner section 25 is connected thereto a combustion fuel supply pipe 44 which is connected to a fuel supply source (not shown) such as, e.g., a city gas pipe, and is also connected to the other end of an offgas supply pipe 72 which is connected at one end to an outlet port of the fuel pole 11. Basically, in the beginning of a starting operation of the fuel cell 10, combustion fuel is supplied to the burner section 25, and during the starting operation of the fuel cell 10, the reforming gas from the CO selective oxidation section 24 is supplied to the burner section 25 without passing through the fuel cell 10. Further, during an ordinary operation of the fuel cell 10, the anode offgas (i.e., hydrogen-containing reforming gas being not consumed at the fuel pole 11) exhausted from the fuel cell 10 is supplied to the burner section 25. The shortfall of the reforming gas or the offgas is replenished with the combustion fuel. Replenishing the shortfall with the combustion fuel may be made to be unnecessary by control.

Further, a combustion air supply pipe 64 is further connected to the burner section 25, and combustion air is supplied from the atmosphere for burning (oxidizing) combustible gas such as, e.g., combustion fuel, anode offgas, reforming gas or the like.

The combustion fuel supply pipe 44 is provided thereon with the combustion fuel pump 45 and the combustion fuel valve 46 in order from the upstream side. The combustion fuel pump 45 constitutes combustion fuel supply means for supplying combustion fuel and for regulating the supply quantity. The combustion fuel valve 46 operates to open or close the combustion fuel supply pipe 44. Further, the combustion air supply pipe 64 is provided thereon with a combustion air pump 65 and a combustion air valve 66 in order from the upstream side. The combustion air pump 65 constitutes combustion oxidizer gas supply means for supplying combustion air as combustion oxidizer gas and for regulating the supply quantity. The combustion air valve 66 operates to open or close the combustion air supply pipe 64.

When the burner section 25 constructed as above is ignited, combustion fuel, reforming gas or anode offgas being supplied thereto is burned with combustion air to generate high temperature combustion gas. The combustion gas flows through a combustion gas flow passage 27 and is exhausted as combustion exhaust gas through an exhaust pipe 81. Thus, the combustion gas heats the reforming section 21 and the evaporator section 26 in this order. The combustion gas flow passage 27 is a flow passage which is arranged to go along the inner circumferential wall of the reforming section 21 in contact with the wall, then along between the outer circumferential wall of the reforming section 21 and a heat insulator section 28 in contact therewith after being turned down, and finally along between the heat insulator section 28 and the evaporator section 26 in contact therewith after being turned up.

The evaporator section 26 is for generating steam by heating and boiling reforming water and for supplying the steam to the reforming section 21 by way of the cooler section 22. The evaporator section 26 is formed to take a cylindrical shape and is provided to cover the outer circumferential wall for the combustion gas flow passage 27 in contact with the wall.

The evaporator section 26 is connected at its lower portion (e.g., a lower part of the lateral wall surface or a bottom surface) to a feedwater pipe 52 which is connected to a reforming water tank (not shown). The evaporator section 26 is connected at its upper portion (e.g., an upper portion on the lateral wall surface) to the aforementioned steam supply pipe 51. The reforming water led from the reforming water tank is heated with the heat of the combustion gas and the heat from the CO selective oxidation section 24 in the course of flowing through the evaporator section 26 and is turned into steam to be led to the reforming section 21 through the stem supply pipe 51 and the cooler section 22. The feedwater pipe 52 is provided thereon with a reforming water pump 53 and a reforming water valve 54 in order from the upstream side. The reforming water pump 53 is for supplying reforming water to the evaporator section 26 and for regulating the supply quantity of the reforming water. The reforming water valve 54 operates to open or close the feedwater pipe 52.

Further, the evaporator section 26 is provided with a temperature sensor 26a for detecting the temperature (TS) of the steam in the evaporator section 26. The detection result of the temperature sensor 26a is transmitted to the system controller 30. As far as the detection of the steam temperature can be done, the temperature sensor 26a may be provided at any other place than the evaporator section 26, such as, e.g., around an inlet port of the cooler section 22 or on the steam supply pipe 51 between the evaporator section 26 and the cooler section 22.

The fuel pole 11 of the fuel cell 10 is connected at its inlet port to the CO selective oxidation section 24 through the reforming gas supply pipe 71 and at its outlet port to the burner section 25 through the offgas supply pipe 72. A bypath pipe 73 bypasses the fuel cell 10 to make direct connection between the reforming gas supply pipe 71 and the offgas supply pipe 72. The reforming gas supply pipe 71 is provided thereon with a first reforming gas valve 74 between a branched point to the bypath pipe 73 and the fuel cell 10. The offgas supply pipe 72 is provided thereon with an offgas valve 75 between a merging point with the bypath pipe 73 and the fuel cell 10. The bypath pipe 73 is provided with a second reforming gas valve 76.

The reforming gas supply pipe 71 is connected to one end of a reforming fuel supply pipe 91 between the first reforming gas valve 74 and the fuel cell 10. The other end of the reforming fuel supply pipe 91 is connected to the reforming fuel supply pipe 41 between the reforming fuel supply pump 42 and the reforming fuel valve 43. The reforming fuel supply pipe 91 is provided with a valve 92 thereon. Thus, when the reforming fuel supply pump 42 is driven with the valve 92 being opened, reforming fuel is supplied to the fuel pole 11 of the fuel cell 10. The reforming fuel supply pipe 91, the valve 92 and the reforming fuel supply pump 42 collectively constitute reforming fuel supply means. The other end of the reforming fuel supply pipe 91 may be connected to the combustion fuel supply pipe 44 between the combustion fuel pump 45 and the combustion fuel valve 46, so that the reforming fuel supply pipe 91 may be modified to work as a combustion fuel supply pipe which supplies combustion fuel to the fuel pole 11 of the fuel cell 10. In this modified form, the combustion fuel supply pipe so modified, the valve 92 and the combustion fuel supply pump 45 collectively constitute combustion fuel supply means.

During a starting operation, the first reforming gas valve 74 and the offgas valve 75 are closed and the second reforming gas valve 76 is opened, so that the reforming gas being high in the density of carbon monoxide is avoided to be supplied from the reformer 20 to the fuel cell 10. During an ordinary operation (during a power generating operation), the first reforming gas valve 74 and the offgas valve 75 are opened and the second reforming gas valve 76 is closed, so that the reforming gas is supplied from the reformer 20 to the fuel cell 10.

The air pole 12 of the fuel cell 10 is connected to a cathode air supply pipe 67 at its inlet port and to an exhaust pipe 82 at its outlet port. The air pole 12 is supplied with air, and offgas is exhausted from the exhaust pipe 82. The cathode air supply pipe 67 is provided with a cathode air pump 68 and a cathode air valve 69 in order from the upstream side. The cathode air pump 68 is for supplying cathode air and for regulating the supply quantity. The cathode air valve 69 operates to open or close the cathode air supply pipe 67.

Further, as shown in FIG. 2, the fuel cell system is provided with the system controller 30, which has connected thereto the temperature sensors 21c, 23c, 24b, 26a, the respective pumps 42, 45, 53, 62, 65, 68, the respective valves 43, 46, 54, 63, 66, 69, 74, 75, 76, 92 and the burner section 25 all aforementioned (refer to FIG. 1). The system controller 30 incorporates therein a microcomputer (not show), which has an input/output interface, a CPU, RAM and ROM (all not shown) connected thereto. The CPU executes the operation of the fuel cell system by controlling the respective pumps 42, 45, 53, 62, 65, 68, the respective valves 43, 46, 54, 63, 66, 69, 74, 75, 76, 92 and the burner section 25 based on the temperatures from the temperature sensors 21c, 23c, 24b, 26a. The RAM temporally stores variables which are necessary to execute a program for the control operation, and the ROM stores the program.

(Operation)

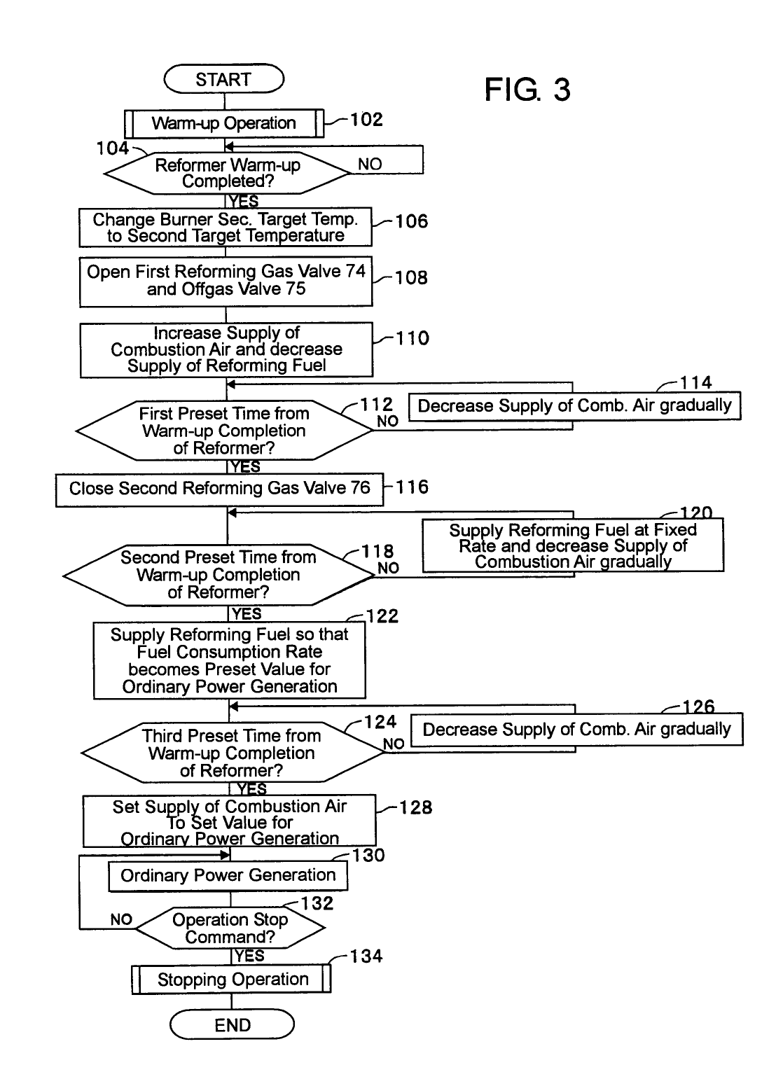

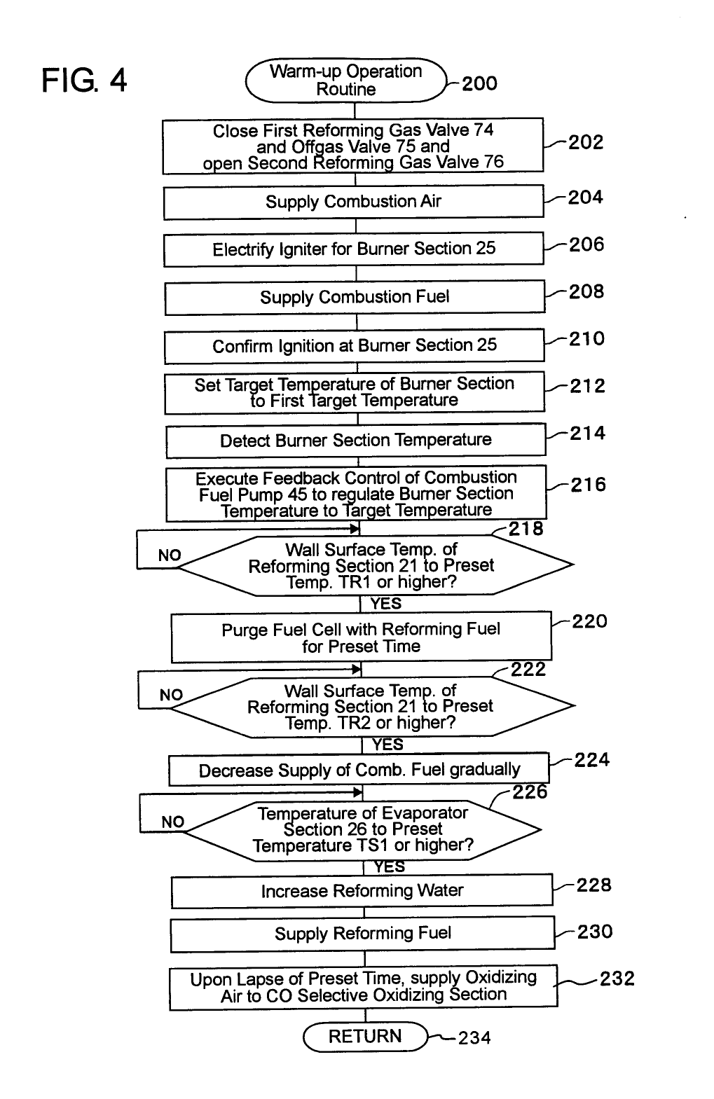

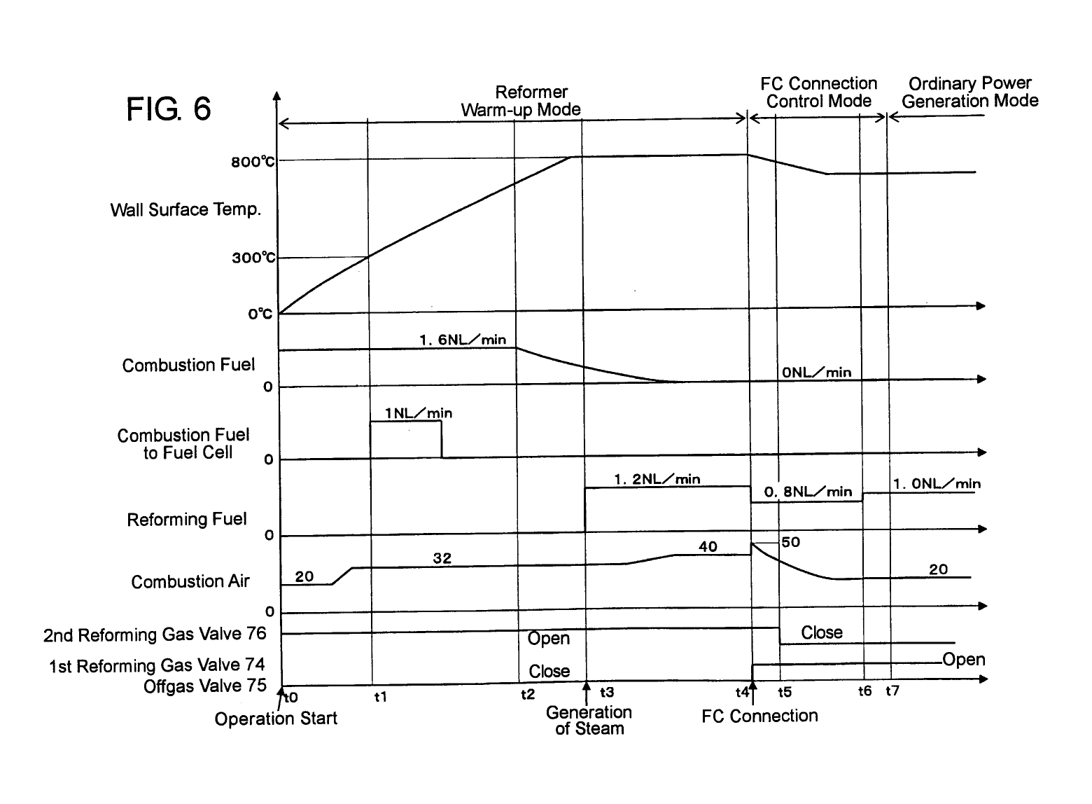

The operation of the fuel cell system as constructed above will be described with reference to FIGS. 3-7. When a start switch (not shown) is turned on at time t0, the system controller 30 starts a warm-up operation of the fuel cell system (step 102). More specifically, the system controller 30 advances the programmed processing to a warm-up operation routine shown in FIG. 4 and performs the warm-up operation of the reformer 20 in accordance with the warm-up operation routine.

The system controller 30 executes processing at step 202 and those subsequent thereto each time it initiates the warm-up operation routine shown in FIG. 4. The system controller 30 closes the first reforming gas valve 74 and the offgas valve 75 and opens the second reforming gas valve 76 to connect the CO selective oxidation section 24 directly to the burner section 24 (step 202).

Then, the system controller 30 opens the combustion air valve 66 and drives the combustion air pump 65 to supply the burner section 25 with combustion air at a predetermined, prescribed flow rate C1 (e.g., 20 NL/min) (step 204). The system controller 30 electrifies an igniter (not shown) built in the burner section 25 (step 206). There may be used a glow plug in place of the igniter.

The system controller 30 opens the combustion fuel valve 46 and drives the combustion fuel pump 45 to supply the burner section 25 with combustion fuel at a predetermined, prescribed flow rate B1 (e.g., 1.6 NL/min) (step 208). At this time, the burner section 25 catches fire.

Further, the system controller 30 stops electrifying the igniter upon the lapse of a predetermined time from the time when the catching fire is detected or the igniter is electrified (step 210). In this way, the combustion of combustion fuel is started at the burner section 25.

The system controller 30 sets a target temperature representing a target combustion state of the burner section 25, to a first target temperature (e.g., 800° C.) representing a first target combustion state (step 212). This first target temperature is higher than a second target temperature (e.g., 700° C.) which is set in an ordinary operation (ordinary power generation mode). This is for the following reasons. That is, in the warm-up operation, since the reformer 20 is desired to complete the warm-up as fast as possible, it is necessary to heat the reformer 20 at a temperature as high as possible which is determined taking the heat-resisting property of the reforming catalyzer 21b into consideration. Further, the second target temperature is set to an optimum temperature which is determined taking the active temperature of the reforming catalyzer 21b into consideration.

Thereafter, the system controller 30 detects the burning temperature (wall surface temperature) of the burner section 25 with the temperature sensor 21c (step 214) and regulates the combustion fuel pump 45 under a feedback control so that the detected burning temperature of the burner section 25 reaches the first target temperature having been set previously (step 21). Thus, the combustion fuel is burned, and the combustion gas flows through the combustion gas flow passage 27, whereby the reforming catalyzer 21a contained in the reforming section 21 and the evaporator section 26 are heated with the combustion gas.

When the wall surface temperature (detected by the temperature sensor 21c) of the burner section 25 reaches a predetermined temperature TR1 (time t1), the system controller 30 judges “YES” at step 218 and purges the fuel pole 11 of the fuel cell 10 with reforming fuel for a predetermined time (e.g., five minutes) and supplies reforming water (step 220). The predetermined temperature TR1 is the temperature at which a flame in the burner section comes to be stable and is about 300° C. in this particular embodiment. Specifically, the system controller 30 opens the valve 92 and the offgas valve 75 and drives the reforming fuel pump 42 to discharge reforming fuel at a prescribed flow rate (e.g., 1 NL/min). Also, the system controller 30 opens the water valve 54 and drives the water pump 53 to supply reforming water at a predetermined flow rate to the reforming section 21 through the evaporator section 26.

This purge is for the following reasons. As mentioned later, in a stopping operation which is executed in stopping the operation of the fuel cell system, the respective valves are closed to hold an airtight state after the reforming gas and the reforming fuel which are left in the reformer 20 are discharged outside. After the stopping of power generation, as time goes on, the temperature of the fuel cell 10 goes down, and the hydrogen being left in the fuel pole 11 flows out a little to the air pole 12 through the electrolyte 13. Thus, the pressure in the fuel pole 11 of the fuel cell 10 which is being held airtight lowers to a negative pressure. To avoid the negative pressure, the fuel pole 11 of the fuel cell 10 is charged with reforming fuel when a predetermined time (e.g., one hour) elapses from the power generation stop. Thus, the deficiency or shortfall which causes the negative pressure is replenished, and after the charging, the valve 92 is closed to hold the airtight state. However, because the fuel cell 10 still remains at a high temperature, the pressure in the fuel pole 11 of the fuel cell 10 being held airtight lowers to a negative pressure. In this case, since the state of the negative pressure continues until the subsequent operation start, air in the atmosphere penetrates the fuel pole 11 of the fuel cell 10 through a membrane of the electrolyte 13 though airtight is held in the fuel pole 11 of the fuel cell 10. In order to purge the air which penetrated the fuel pole 11, the fuel pole 11 of the fuel cell 10 is purged with reforming fuel for a predetermined time (e.g., five minutes) at the time of the operation start. Then, upon completion of the purge, the system controller 30 discontinues the driving of the reforming fuel pump 42 and closes the valve 92 and the offgas valve 75.

When the wall surface temperature of the reforming section 21 (the temperature from the temperature sensor 21c) reaches a predetermined temperature TR2 (time t2), the system controller 30 judges “YES” at step 222 and gradually decreases the supply quantity of combustion fuel by controlling the combustion fuel pump 45 until the supply is stopped finally (step 224). The predetermined temperature TR2 is an endurance limit temperature of the burner section 25 and is about 600° C. in this particular embodiment.

The system controller 30 detects the temperature of the evaporator section 26 by the temperature sensor 26a and, if the detected temperature is higher than the predetermined temperature TS1 (time t3), judges “YES” at step 226 to increase the reforming water (step 228).

Then, the system controller 30 operates to supply reforming fuel (step 230). Specifically, the system controller 30 opens the reforming fuel valve 43 and drives the reforming fuel pump 42 to supply reforming fuel at a predetermined flow rate (e.g., 1.2 NL/min) to the reforming section 21. The supply of reforming fuel may be started after the lapse of a short time from the beginning of the supply of reforming water.

Further, the system controller 30 operates to supply oxidizing air to the CO selective oxidation section 24 upon lapse of a predetermined time from the supply of reforming fuel. Specifically, the system controller 30 opens the oxidizing air valve 63 and drives the oxidizing air pump 62 to supply oxidizing air at a predetermined flow rate to the CO selective oxidation section 24.

Thus, the reforming section 21 is supplied with mixture gas which is a mixture of reforming fuel and steam, wherein the steam reforming reaction and the carbon monoxide shift reaction as aforementioned are induced to generate reforming gas. Then, the reforming gas led from the reforming section 21 is reduced in carbon monoxide gas at the CO shift section 23 and the CO selective oxidation section 24 to be led from the CO selective oxidation section 24 and, without passing through (i.e., by bypassing) the fuel cell 10, is supplied directly to the burner section 25 to be burned there.

Then, after execution of the processing at step 232, the system controller 30 advances the program to step 234 to discontinue this routine and proceeds to step 104 shown in FIG. 3.

During the aforementioned generation of reforming gas, the system controller 30 at step 104 detects the temperatures of the reforming section 21, the CO shift section 23 and the CO selective oxidation section 24 by the respective temperature sensors 21c, 23c, 24b. If the temperatures detected by the respective temperature sensors 21c, 23c, 24b are lower than respective predetermined temperatures which have been set in advance, there is made a judgment that the warm-up operation of the reformer 20 has not been completed, and the processing at step 104 is executed repetitively. If the temperatures detected by the respective temperature sensors 21c, 23c, 24b reach the respective predetermined temperatures or higher (time t4), the warm-up operation of the reformer 20 is judged to have been completed, and the program is advanced to step 106. Thus, the reformer warm-up mode for warming up the reformer 20 is terminated, and an FC connection control mode begins. The FC connection control mode is a control mode for moving from the reformer warm-up mode to an ordinary power generation mode in which the fuel cell 10 performs ordinary power generation.

At step 106, the system controller 30 changes the burner section target temperature which has previously been set to the first target temperature at step 212, to a second target temperature on or after the time when the warm-up of the reformer 20 is completed. Thus, the system controller 30 detects the burning temperature at the burner section 25 by the temperature sensor 21c and performs a feedback control of the combustion fuel pump 45 so that the detected burning temperature (the temperature from the temperature sensor 21c) at the burner section 25 is controlled to reach the second target temperature so set. Accordingly, the temperature of the reforming section 21 is lowered to an active temperature for the reforming catalyzer 21b.

Further, the system controller 30 opens the first reforming gas valve 74 and the offgas valve 75 on and after the warm-up of the reformer 20 is completed (time t4) (step 108). Thus, at time t4, the CO selective oxidation section 24 is brought into connection to the inlet port of the fuel pole 11 of the fuel cell 10, and the outlet port of the fuel pole 11 is brought into connection to the burner section 25. As a result, the fuel gas generated in the reforming section 21 is supplied to the burner section 25 through both of a first flow passage (the flow passage which passes through the fuel cell 10) and a second flow passage (the flow passage which does not pass through the fuel cell 10).

Further, the system controller 30 controls the combustion air pump 65 to increase the supply quantity of combustion air (step 110). The supply quantity has been set to be larger than that supplied when the reforming fuel (or combustion fuel) existing in the fuel pole 11 is not supplied to the burner section 25. For example, the supply quantity is increased from 40 NL/min to 50 NL/min. At this time, since the combustion air to be supplied is to be as much as possible, the supply quantity is preferable to be set to the maximum discharge rate of the combustion air pump 65. Furthermore, the system controller 30 controls the reforming fuel pump 42 to decrease the supply quantity of the reforming fuel (step 110). The supply quantity has been set to be a smaller value than that supplied when the reforming fuel (or combustion fuel) existing in the fuel pole 11 is not supplied to the burner section 25. For example, the supply quantity is decreased from 1.2 NL/min to 0.8 NL/min.

The supply quantity of the combustion air cannot be increased beyond the maximum discharge rate of the combustion air pump 65. If a target air-fuel ratio cannot be reached even at the maximum discharge rate, it can be reached by decreasing the supply quantity of the reforming fuel. This is an advantage of the fuel cell system in the present embodiment.

The increase of the combustion air and the decrease of the reforming fuel are both made at step 110. In a modified form, either of them may be made.

During the period from the time when the warm-up of the reformer 20 is completed (time t4: when the first reforming gas valve 74 and the offgas valve 75 are opened), to the time (time t5) when a first predetermined time T1 (e.g., five seconds) elapses, the system controller 30 judges “NO” at step 112 to decrease the supply quantity of the combustion air gradually (step 114). Then, upon expiration (time t5) of the first predetermined time T1 from the time point (time t4) when the warm-up of the reformer 20 is completed, the system controller 30 judges “YES” at step 112 to close the second reforming gas valve 76 (step 116).

During the period from the time (time t4) when the warm-up of the reformer 20 is completed, to the time (t6) when a second predetermined time T2 (e.g., 100 seconds) elapses, the system controller 30 judges “NO” at step 118 to continue the supply of the reforming fuel at the fixed flow rate (the flow rate set at step 110: 0.8 NL/min) and to decrease the supply quantity of the combustion air gradually in the same manner as did at step 114 (step 120). Then, upon expiration (time t6) of the second predetermined time T2 from the time point (time t4) when the warm-up of the reformer 20 is completed, the system controller 30 judges “YES” at step 118 and drives the reforming fuel pump 42 to supply reforming fuel at a supply flow rate (e.g., 1.0 NL/min) which makes the fuel consumption rate a predetermined value set during the ordinary power generation (step 122).

During the period from the time (time t4) when the warm-up of the reformer 20 is completed, to the time (t7) when a third predetermined time T3 (e.g., 150 seconds) lapses, the system controller 30 judges “NO” at step 124 to decrease the supply quantity of the combustion air gradually in the same manner as did at step 114 (step 126). Then, upon expiration (time t7) of the third predetermined time T3 from the time point (time t4) when the warm-up of the reformer 20 is completed, the system controller 30 judges “YES” at step 124 and drives the combustion air pump 64 to supply combustion air at a supply flow rate (e.g., 20 NL/min) set during the ordinary power generation (step 128).

The system controller 30 repetitively executes the processing of steps 130 and 132 until given an operation stop command. That is, the system controller 30 controls the supplies of reforming fuel, combustion fuel, combustion air, oxidizer air, cathode air and reforming water so that the quantity of hydrogen generated in the reformer 20 becomes a predetermined quantity, in other wards, so that the output current of the fuel cell system becomes a desired output current which is determined in dependence on the current and the electric power used at cites of power use (step 130). Then, when given the operation stop command upon depression of the stop switch or the like, the system controller 30 stops the fuel cell system (steps 132, 134).

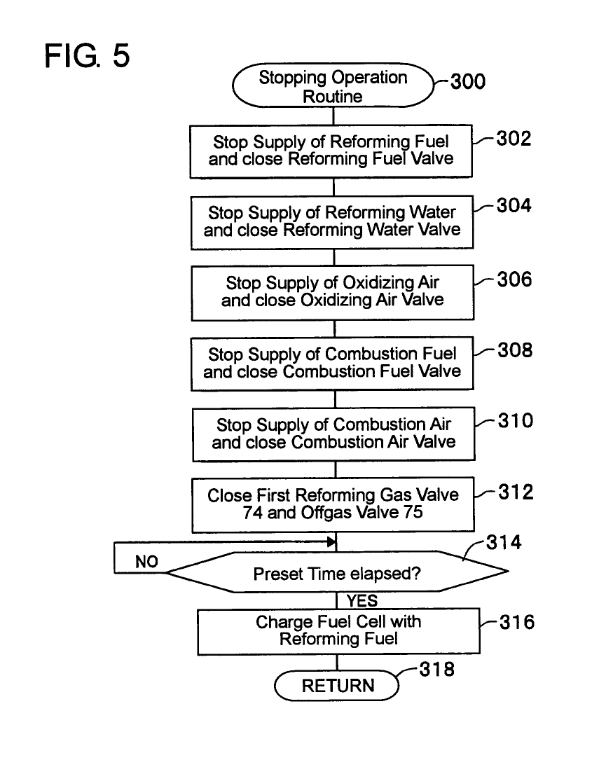

The system controller 30 executes processing for stopping the fuel cell system (a stopping operation) at step 134. Specifically, the system controller 30 proceeds to a stopping operation routine shown in FIG. 5 and executes the stopping operation of the reformer 20 in accordance with this stopping operation routine.

Each time of starting this routine, the system controller 30 executes processing at step 302 and those subsequent thereto. The system controller 30 stops driving the reforming fuel pump 42 to discontinue the supply of reforming fuel and closes the reforming fuel valve 43 (step 302). The system controller 30 stops driving the reforming water pump 53 to discontinue the supply of reforming water and closes the reforming water valve 54 (step 304). The system controller 30 stops driving the oxidizing air pump 62 to discontinue the supply of oxidizing air and closes the oxidizing air valve 63 (step 306). The system controller 30 stops driving the combustion fuel pump 45 to discontinue the supply of combustion fuel and closes the combustion fuel valve 46 (step 308). The system controller 30 stops driving the combustion air pump 65 to discontinue the supply of combustion air and closes the combustion air valve 66 (step 310). Finally, the system controller 30 closes the first reforming gas valve 74, the offgas valve 75, the second reforming gas valve 76 and the valve 92, whereby the power generation by the fuel cell 10 is stopped.

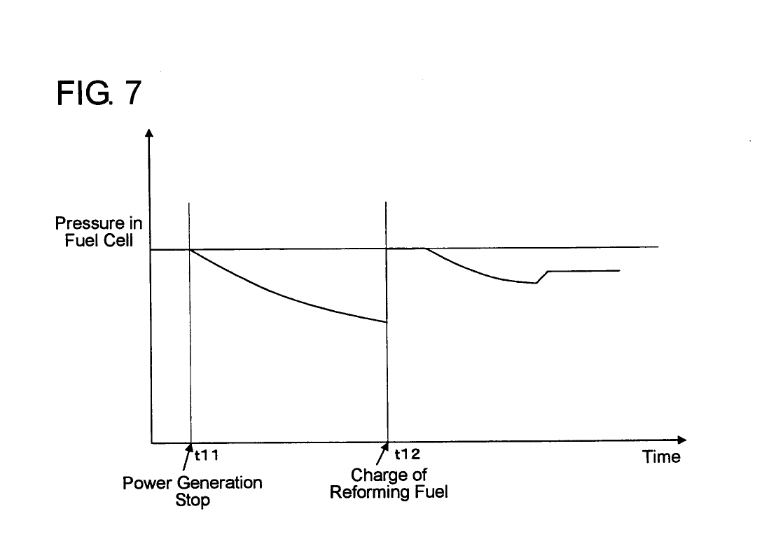

Subsequently, as shown in FIG. 7, after lapse of a predetermined time (e.g., one hour) from the time (time t11) at which the power generation by the fuel cell 10 was stopped, the system controller 30 at time t12 operates to charge the fuel cell 10 with reforming fuel (step 316). Specifically, the system controller 30 opens the valve 92 only and drives the reforming fuel pump 42 to charge the fuel pole 11 of the fuel cell 10 with reforming fuel. After the power generation is stopped at time t11, the fuel cell 10 lowers in temperature as time goes on, and the hydrogen remaining in the fuel pole 11 flows a little to the air pole 12 through the electrolyte 13. This causes the pressure in the closed fuel pole 11 of the fuel cell 10 to lower to a negative pressure. The aforementioned supply of the reforming fuel at time t12 replenishes the shortfall which caused the negative pressure, whereby the pressure in the closed fuel pole 11 of the fuel cell 10 returns to the value which the fuel pole 11 had at the time (t11) of the operation stop. After the charging, the operation of the reforming fuel pump 42 is stopped, and the vale 92 is closed to hold the fuel pole 11 in the closed state.

As clear from the foregoing description, in the present embodiment, in supplying the offgas from the fuel pole 11 to the burner section 25, the system controller 30 takes into consideration the fact that the burner section 25 is supplied with either one of the reforming fuel and the combustion fuel which exists in the fuel pole 11 and regulates the combustion at the burner section 25 (step 110: combustion regulation means). Therefore, even if the burner section 25 is suddenly supplied with combustible fuel which exists in the fuel pole 11 of the fuel cell 10 and which differs from the combustible fuel having been supplied to the burner section 25 until then, the combustion at the burner section 25 is regulated taking into consideration the fact that the burner section 25 is supplied with the combustible fuel which exists in the fuel pole 11 of the fuel cell 10. This results in keeping an adequate ratio of air to the combustible fuel (i.e., air-fuel ratio), so that the emission of the exhaust gas from the burner section 25 can be prevented from being deteriorated or from becoming worse.

Further, the combustion regulation means controls the reforming fuel pump 42 operating as reforming fuel supply means or the combustion fuel pump 45 operating as combustion fuel supply means to decrease the supply quantity of at least either one of the reforming fuel and the combustion fuel in comparison with that which is set where the burner section 25 is not supplied with the combustion fuel or the reforming fuel existing in the fuel pole 11. Thus, when the burner section 25 is supplied with the combustible fuel existing in the fuel pole 11 of the fuel cell 10, the total supply quantity of combustible fuel supplied to the burner section 25 would otherwise be increased by the quantity corresponding to such supply. However, the supply quantity of either one of the reforming fuel and the combustion fuel supplied to the burner section 25 is decreased, so that the combustion at the burner section 25 can be regulated adequately without changing the total supply quantity of combustible fuel supplied to the burner section 25.

Furthermore, the combustion regulation means controls the combustion air pump 65 operating as combustion oxidizer gas supply means to increase the supply quantity of the combustion oxidizer gas in comparison with that which is set where the burner section 25 is not supplied with either one of the reforming fuel and the combustion fuel existing in the fuel pole 11. Thus, although the total supply quantity of combustible fuel supplied to the burner section is increased by the quantity of the combustible fuel supplied from the fuel pole 11 of the fuel cell 10 to the burner section 25, the supply quantity of the combustion oxidizer gas is also increased. Therefore, the air-fuel ratio can be maintained adequately to regulate the combustion at the burner section 25 adequately.

Still furthermore, either one of the supply of reforming fuel and the supply of combustion fuel to the fuel pole 11 of the fuel cell 10 is executed either at the time of the operation start or during the stopping operation or during the operation stop of the fuel cell system. Thus, where combustible fuel differing from the reforming gas exists in the fuel pole 11 of the fuel cell 10 after the fuel pole 11 of the fuel cell 10 is purged with reforming fuel or combustion fuel, it can be realized to prevent the emission of the exhaust gas from the burner section 25 from becoming worse or deteriorated even when the burner section 25 is supplied with the existing combustible fuel. Here, the term “at the time of the operation start” means the state of the reformer 20 being during the warm-up operation (step 102), the term “the stopping operation” means the state in which the burner section 25 is being cooled in accordance with the stopping operation routine (from step 302 until “YES” is judged at step 314), and the term “during the operation stop” means the state after the cooling of the burner section 25 (step 316).

In addition, since the combustion regulation means regulates the combustion at the burner section 25 in the FC connection control mode which is a transition mode from the warm-up mode as an operation starting mode for the fuel cell system to the ordinary power generation mode as the power generation mode, the ratio of air to combustible fuel (i.e., air-fuel ratio) can be maintained to be adequate in depending on the combustible fuel supplied to the burner section 25, so that it can be realized to prevent the emission of the exhaust gas from the burner section 25 from becoming worse or deteriorated. The operation starting mode lasts until fuel gas is supplied to the fuel pole (anode) 11 of the fuel cell 10 after an operation start command is given to the reformer 20 (reformer warm-up mode), whereas the power generation mode lasts until a stop processing command is given after fuel gas is supplied to the fuel pole 11 of the fuel cell 10 (i.e., ordinary power generation mode of the reformer 20).

Obviously, numerous further modifications and variations of the present invention are possible in light of the above teachings. It is therefore to be understood that within the scope of the appended claims, the present invention may be practiced otherwise than as specifically described herein.

What is claimed is:

1. A fuel cell system comprising:
a fuel cell for generating electric power through the reaction of fuel gas with oxidizer gas which are supplied respectively to a fuel pole and an oxidizer pole thereof;
a reforming section for generating the fuel gas from reforming fuel supplied from reforming fuel supply means;
a burner section for burning either combustible fuel of combustion fuel supplied from combustion fuel supply means, the fuel gas supplied from the reforming section and offgas supplied from the fuel pole, with combustion oxidizer gas supplied from combustion oxidizer gas supply means and for heating the reforming section with combustion gas;
supply means for supplying either one of the reforming fuel and the combustion fuel to the fuel pole of the fuel cell; and
a system controller including combustion regulation means for regulating combustion at the burner section, wherein in supplying the offgas from the fuel pole to the burner section, the system controller regulates, through the combustion regulation means, the combustion at the burner section in consideration of the fact that the burner section is supplied with at least one of reforming fuel and combustion fuel which exists in the fuel pole of the fuel cell.

2. The fuel cell system as set forth in claim 1, wherein the combustion regulation means controls the reforming fuel supply means or the combustion fuel supply means to decrease the supply quantity of at least either one of the reforming fuel and the combustion fuel in comparison with a supply quantity thereof which is set where the burner section is not supplied with the combustion fuel or the reforming fuel existing in the fuel pole.

3. The fuel cell system as set forth in claim 1, wherein the combustion regulation means controls the combustion oxidizer gas supply means to increase the supply quantity of the combustion oxidizer gas in comparison with a supply quantity thereof which is set where the burner section is not supplied with the combustion fuel or the reforming fuel existing in the fuel pole.

4. The fuel cell system as set forth in claim 2, wherein the combustion regulation means controls the combustion oxidizer gas supply means to increase the supply quantity of the combustion oxidizer gas in comparison with a supply quantity thereof which is set where the burner section is not supplied with the combustion fuel or the reforming fuel existing in the fuel pole.

5. The fuel cell system as set forth in claim 1, wherein the supply of either one of the reforming fuel and the combustion fuel to the fuel pole of the fuel cell is executed either at the time of an operation start of the fuel cell system or during a stopping operation of the fuel cell system or during an operation stop of the fuel cell system.

6. The fuel cell system as set forth in claim 2, wherein the supply of either one of the reforming fuel and the combustion fuel to the fuel pole of the fuel cell is executed either at the time of an operation start of the fuel cell system or during a stopping operation of the fuel cell system or during an operation stop of the fuel cell system.

7. The fuel cell system as set forth in claim 3, wherein the supply of either one of the reforming fuel and the combustion fuel to the fuel pole of the fuel cell is executed either at the time of an operation start of the fuel cell system or during a stopping operation of the fuel cell system or during an operation stop of the fuel cell system.

8. The fuel cell system as set forth in claim 1, wherein the combustion regulation means regulates the combustion at the burner section in a transition mode from an operation starting mode to a power generation mode of the fuel cell system.

9. The fuel cell system as set forth in claim 2, wherein the combustion regulation means regulates the combustion at the burner section in a transition mode from an operation starting mode to a power generation mode of the fuel cell system.

10. The fuel cell system as set forth in claim 3, wherein the combustion regulation means regulates the combustion at the burner section in a transition mode from an operation starting mode to a power generation mode of the fuel cell system.

11. The fuel cell system as set forth in claim 5, wherein the combustion regulation means regulates the combustion at the burner section in a transition mode from an operation starting mode to a power generation mode of the fuel cell system.
